(19) United States
(12) Patent Application Publication
(10) Pub. No.: US 2025/0265528 A1
(43) Pub. Date: Aug. 21, 2025

(54) SYSTEM AND METHOD FOR CALCULATING A SCORE OF AN OUTBOUND-MARKETING INTERACTION

(71) Applicant: NICE LTD., Ra'anana (IL)

(72) Inventors: Onkar HINGNE, Pune Maharashtra (IN); Abhijit MOKASHI, Pune Maharashtra (IN)

(21) Appl. No.: 18/442,132

(22) Filed: Feb. 15, 2024

(51) Int. Cl. G06Q 10/0639; G06N 3/0455

(52) U.S. Cl. CPC G06Q 10/06393; G06N 3/0455

(57) ABSTRACT

A computerized-method for calculating a score of an outbound-marketing interaction. The computerized-method includes: (i) retrieving a transcription of the outbound-marketing interaction; (ii) identifying a product that is being marketed in the outbound-marketing interaction by executing an Artificial Intelligence (AI) Large Language Model (LLM) with a check-product-prompt having the transcription embedded therein; (iii) constructing a prompt based on: (a) the identified product; (b) one or more features of the identified product; (c) the transcription; and (d) one or more questions. Each question is related to a section in one or more preconfigured-sections; (iv) executing the AI LLM with the constructed prompt to yield an answer and a question-score to each question of the one or more questions; (v) calculating the score of the outbound-marketing interaction based on the question-score of each question; and (vi) sending the score to one or more applications for follow-on actions based on the score.

### TECHNICAL FIELD

The present disclosure relates to the field of data analysis and more specifically, to computerized systems and methods for calculating a score of an outbound-marketing interaction by using Generative Artificial Intelligence (AI) tools.

### BACKGROUND

In contact centers, agents reach out customers during sales or outbound marketing campaign, via various channels, such as voice calls, email, chat, Short Message Service (SMS), and social media, e.g., Instagram®, Facebook®, Twitter®. During the agents interactions with the customers, they try to sale or market a product or a service. While doing that they try to generate customer's interests in the product, address customer queries and concerns, explain benefits or discounts or offers among other things.

In current technical systems in contact centers, there is no measurement of agent's level of performance during sales or marketing interaction that is based on the content of the conversation itself, for quality assurance purposes. Current technical solutions use historical customer interactions to build a machine learning model which is based on certain predefined calculated features. However, these solutions are not accurate as they are based on predefined mathematical calculation and do not analyze the content of the real conversation between the agent and the customer.

Current Quality Management (QM) applications filter interactions for evaluation and quality assurance based on metadata of the interaction, such as call duration, skills communication channels and the like and not based on calculated performance of the agent during that interaction. However, metadata of the interaction, such as call duration may not guarantee that the interactions which are filtered for evaluation by the QM application are the interactions that require evaluation based on business needs and sales effectiveness measurements.

Therefore, there is a need for a technical solution that will provide a measurement of a level of sales effectiveness of agents in generating customer interest, during interactions with customers, e.g., Key Performance Indicator (KPI), for effectively filtering interactions for evaluation, based on one or more parameters that are related to an outbound marketing campaign. There is a need for system and method for calculating a score of an outbound-marketing interaction.

### SUMMARY

There is thus provided, in accordance with some embodiments of the present disclosure, a computerized-method for calculating a score of an outbound-marketing interaction.

In accordance with some embodiments of the present disclosure, the computerized-method may include: (i) retrieving a transcription of the outbound-marketing interaction; (ii) identifying a product that is being marketed in the outbound-marketing interaction by executing an Artificial Intelligence (AI) Large Language Model (LLM) with a check-product-prompt having the transcription embedded therein; (iii) constructing a prompt based on: (a) the identified product; (b) one or more features of the identified product; (c) the transcription; and (d) one or more questions. Each question is related to a section in one or more preconfigured-sections; (iv) executing the AI LLM with the constructed prompt to yield an answer and a question-score to each question of the one or more questions; (v) calculating the score of the outbound-marketing interaction based on the question-score of each question; and (vi) sending the score to one or more applications for follow-on actions based on the score.

Furthermore, in accordance with some embodiments of the present disclosure, the computerized-method may be operated for each outbound-marketing interaction of outbound-marketing interactions of the tenant, that have been retrieved based on preconfigured one or more outbound-skills of the tenant and have been conducted during a preconfigured period.

Furthermore, in accordance with some embodiments of the present disclosure, the computerized-method may be operated periodically for each tenant of the cloud-based contact-center platform.

Furthermore, in accordance with some embodiments of the present disclosure, the product that is identified may be one of a service or a physical product.

Furthermore, in accordance with some embodiments of the present disclosure, the one or more features of the identified product may be retrieved from product-features database of the tenant.

Furthermore, in accordance with some embodiments of the present disclosure, the one or more features of the identified product may be identified by executing the AI LLM with check-features-prompt having the transcription embedded therein to yield the one or more features.

Furthermore, in accordance with some embodiments of the present disclosure, the plurality of questions is one of: (i) preconfigured questions by the tenant; and (ii) a set of default-questions.

Furthermore, in accordance with some embodiments of the present disclosure, the score may be a customer-interest score, and the one or more preconfigured-sections may be customer-preconfigured-sections, and each section may be a customer-section The customer-preconfigured-sections may include at least one of: (i) awareness; (ii) interest; (iii) desire; (iv) action; and (v) sales-conversion. Each customer-preconfigured-section score may be stored in an interactions-database.

Furthermore, in accordance with some embodiments of the present disclosure, the calculating of the customer-interest score is according to formula I:

$$customer\_interest score = {\sum }_{k = i}^{n} customer\_section \_weight i * customer\_section \_score i \qquad ( I )$$

whereby:
n is a number of the one or more customer-preconfigured-sections,
customer_section_weightᵢ is a weight that has been assigned to customer-sectionᵢ, and
customer_section_scoreᵢ is an average score of questions related to customer-sectionᵢ divided by maximum-score for customer-sectionᵢ.

Furthermore, in accordance with some embodiments of the present disclosure, the score may be agent-effectiveness score and the one or more preconfigured-sections are agent-preconfigured-sections, and each section is an agent-section said agent-preconfigured-sections comprising at least one of: (i) communication; (ii) script_coverage; (iii) product_knowledge; and (iv) building_rapport. Each agent-preconfigured-section score may be stored in an interactions-database.

Furthermore, in accordance with some embodiments of the present disclosure, the calculating of the agent-effectiveness score may be according to formula II:

$$agent\_effectiveness score = {\sum }_{k = i}^{n} agent\_section \_weight i * agent\_section \_score i \qquad ( II )$$

whereby:
n is a number of the one or more agent-preconfigured-sections,
agent_section_weightᵢ is a weight that has been assigned to agent-sectionᵢ, and
agent_section_scoreᵢ is an average score of agent-questions related to agent-sectionᵢ divided by maximum-score for agent-sectionᵢ.

Furthermore, in accordance with some embodiments of the present disclosure, the one or more applications are at least one of: (i) Quality Management (QM) application; (ii) coaching application; and (iii) outbound-dialer service, and the follow-on actions are at least one of: (i) configuring the QM application to filter interactions for evaluations based on a preconfigured threshold; (ii) assigning an agent of the related interaction to a coaching session; and (iii) prioritizing customer call-back via the outbound-dialer service and triggering outbound-interactions accordingly.

There is further provided, in accordance with some embodiments of the present invention, a computerized-system for calculating a score of an outbound-marketing interaction.

Furthermore, in accordance with some embodiments of the present disclosure, the computerized-system includes one or more processors, an interactions-database, and a memory to store the interactions-database.

Furthermore, in accordance with some embodiments of the present disclosure, the one or more processors may be configured to: (i) retrieve a transcription of the outbound-marketing interaction from the interactions-database; (ii) identify a product that is being marketed in the outbound-marketing interaction by executing an Artificial Intelligence (AI) Large Language Model (LLM) with a check-product-prompt having the transcription embedded therein; (iii) construct a prompt based on: (a) the identified product; (b) one or more features of the identified product; (c) the transcription; and (d) one or more questions. Each question is related to a section in one or more preconfigured-sections; (iv) execute the AI LLM with the constructed prompt to yield an answer and a question-score to each question of the one or more questions; (v) calculate the score of the outbound-marketing interaction based on the question-score of each question; and (vi) send the score to one or more applications for follow-on actions based on the score.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIGS. 1A-1B schematically illustrate a high-level diagram of a computerized-system for calculating a score of an outbound-marketing interaction, in accordance with some embodiments of the present invention;

FIGS. 2A-2B schematically illustrate a high-level diagram of a computerized-method for calculating a score of an outbound-marketing interaction, in accordance with some embodiments of the present invention;

FIG. 3 is an example of parameters of two Key Performance Indicators (KPI) s, in accordance with some embodiments of the present invention;

FIG. 4 schematically illustrates a high-level diagram of using a score of an outbound-marketing interaction in a performance management application, in accordance with some embodiments of the present invention;

FIG. 5 schematically illustrates a high-level diagram of goal evaluation, in accordance with some embodiments of the present invention;

FIG. 6 schematically illustrates a high-level diagram of quality management application, in accordance with some embodiments of the present invention;

FIG. 7 schematically illustrates a high-level diagram of calculating KPIs for each tenant, in accordance with some embodiments of the present invention;

FIGS. 8A-8C schematically illustrate a high-level diagram of calculating a score of an outbound-marketing interaction, in accordance with some embodiments of the present invention;

FIG. 9 is an example of a transcription of the outbound-marketing interaction, in accordance with some embodiments of the present invention;

FIGS. 10A-10B are examples of prompts to identify a product and features, in accordance with some embodiments of the present invention;

FIGS. 11A-11b show an example of prompt and result of customer interest, in accordance with some embodiments of the present invention;

FIGS. 12A-12B show an example of prompt and result of agent-effectiveness, in accordance with some embodiments of the present invention; and

FIG. 13 is an example of a screenshot of a User Interface to display the scores of the outbound-marketing interactions, in accordance with some embodiments of the present invention.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

At present, there are no technical solutions that use the power of Large Language Model (LLM) for calculating agent performance in generating customer interest and sales effectiveness during interactions. Current technical solutions use historical customer interactions to build a machine learning model based on predefined calculated feature. However, these technical solutions are not accurate as they are based on predefined mathematical calculations and don't analyze the content of the conversation between the agent and the customer.

Other technical solutions are based on sales effectiveness as a single metric which is not enough to bring out insights as to agent's performance in the aspect of sales effectiveness. Many of the current technical solutions use keywords and category searches to compute the sales effectiveness score.

Also, currently there are no technical solutions that use cloud providers for Generative Artificial Intelligence (Gen AI) and the power of LLM to accurately measure metrics such as, awareness, interest, desire and action, communication, script coverage, product knowledge, building rapport and the like.

Therefore, there is a need for a technical solution for calculating a score of an outbound-marketing interaction.

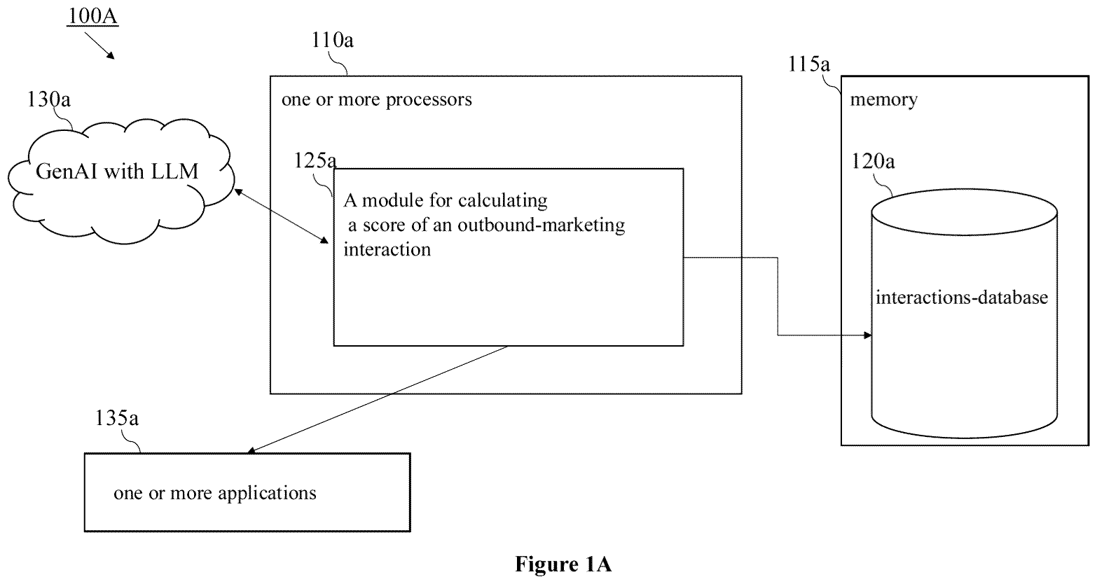

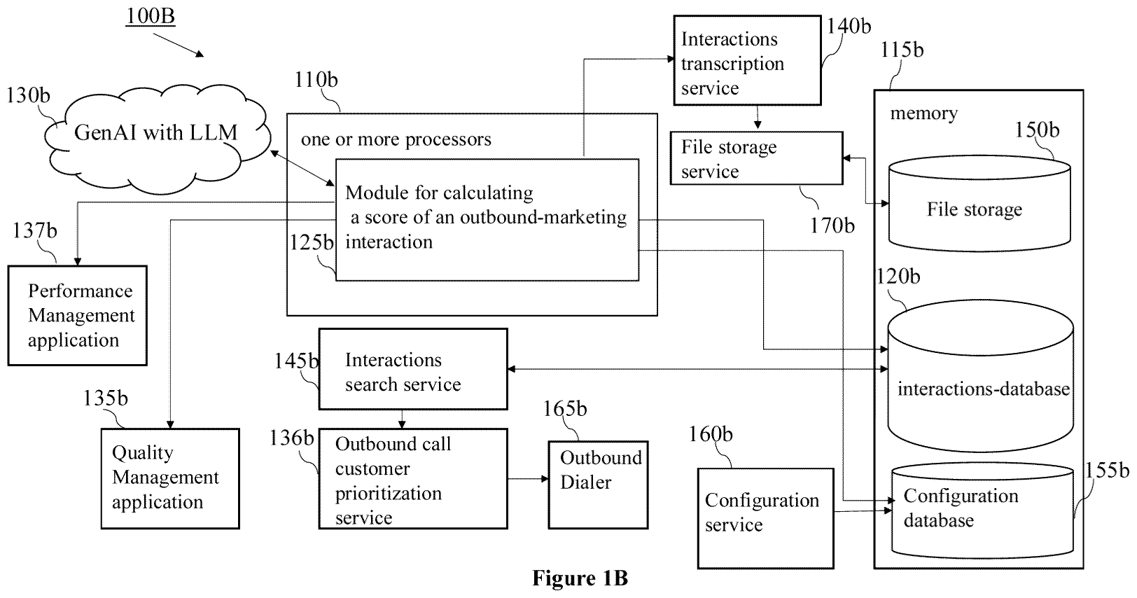

FIG. 1A schematically illustrates a high-level diagram of a computerized-system 100A for calculating a score of an outbound-marketing interaction, in accordance with some embodiments of the present invention.

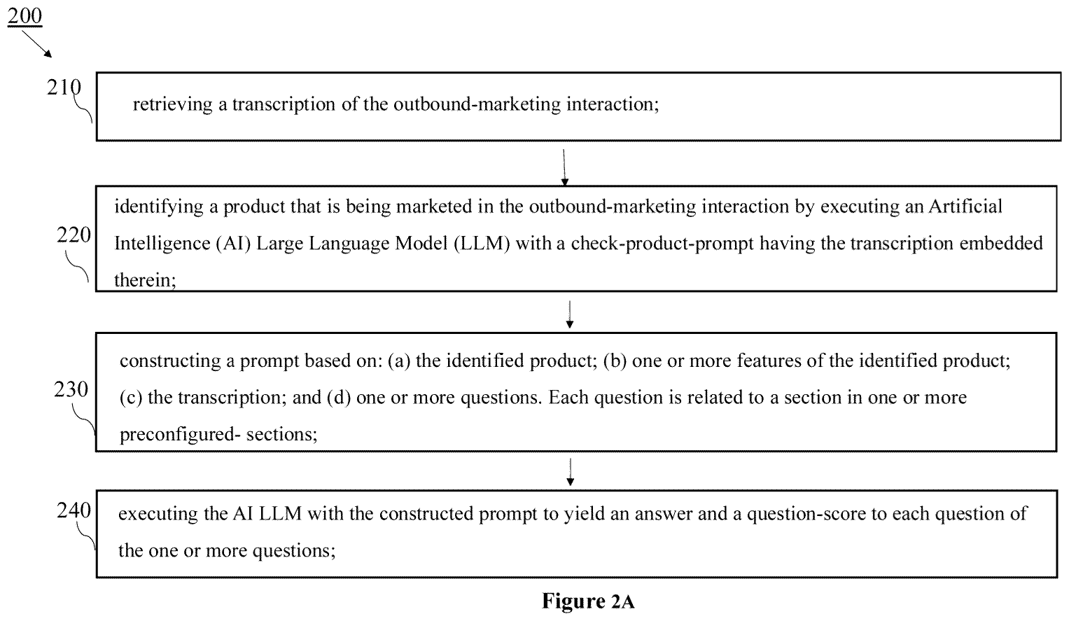

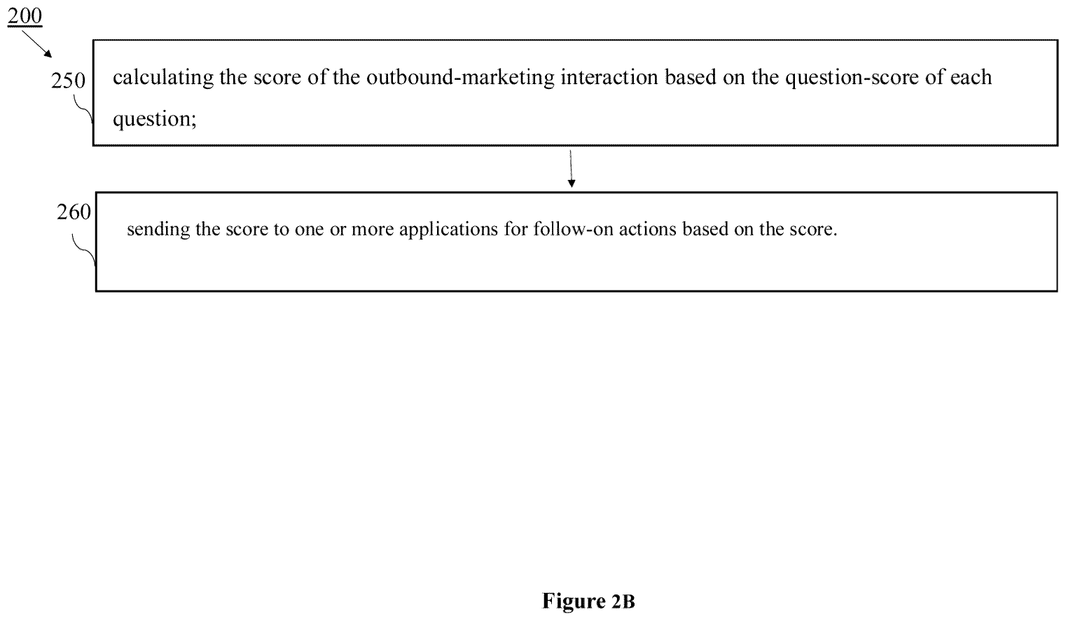

According to some embodiments of the present disclosure, a system, such as system 100A may implement a computerized-method, such as computerized-method for calculating a score of an outbound-marketing interaction 200 in FIGS. 2A-2B. The calculated score may be sent and used for follow-on actions by one or more applications 135a. The outbound-marketing interaction may be an interaction that has been conducted via a cloud-based contact-center platform for a tenant.

According to some embodiments of the present disclosure, system 100A may calculate the score for an outbound-marketing interaction which may be used to effectively filter the interaction based on one or more criteria. For example, the customer was interested in the product but did not purchase the product or service, the agent failed to generate customer interest due to lack of product knowledge, an interested customer was lost due to poor rapport building by the agent, a desiring customer did not proceed to buy the product or service because the customer was not happy with the pricing or charges in comparison to a competitor, or lack of discounts.

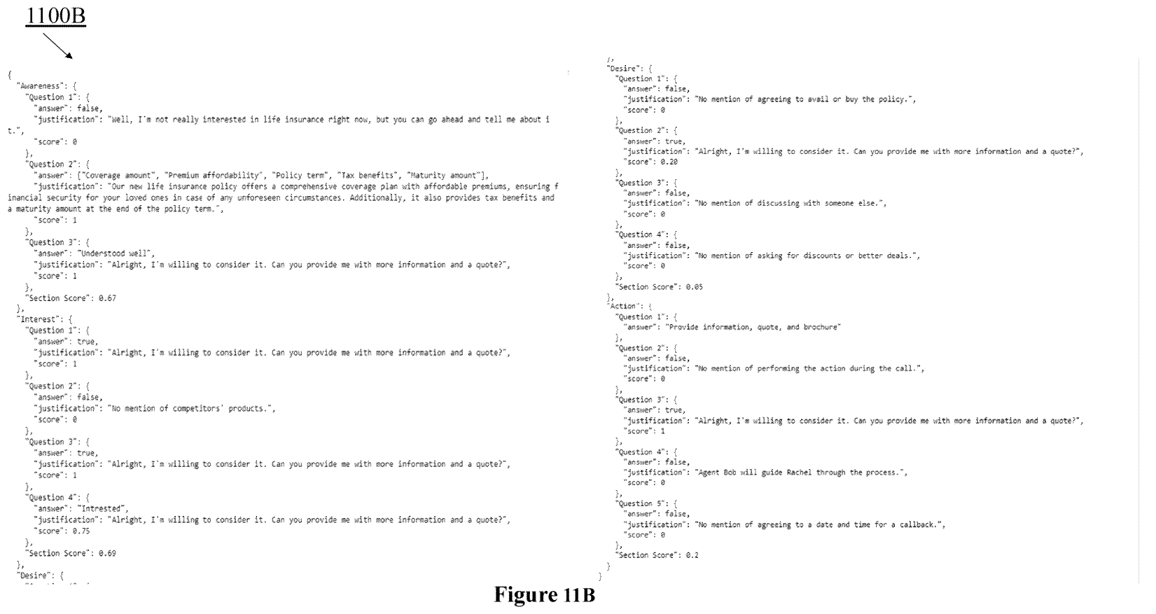

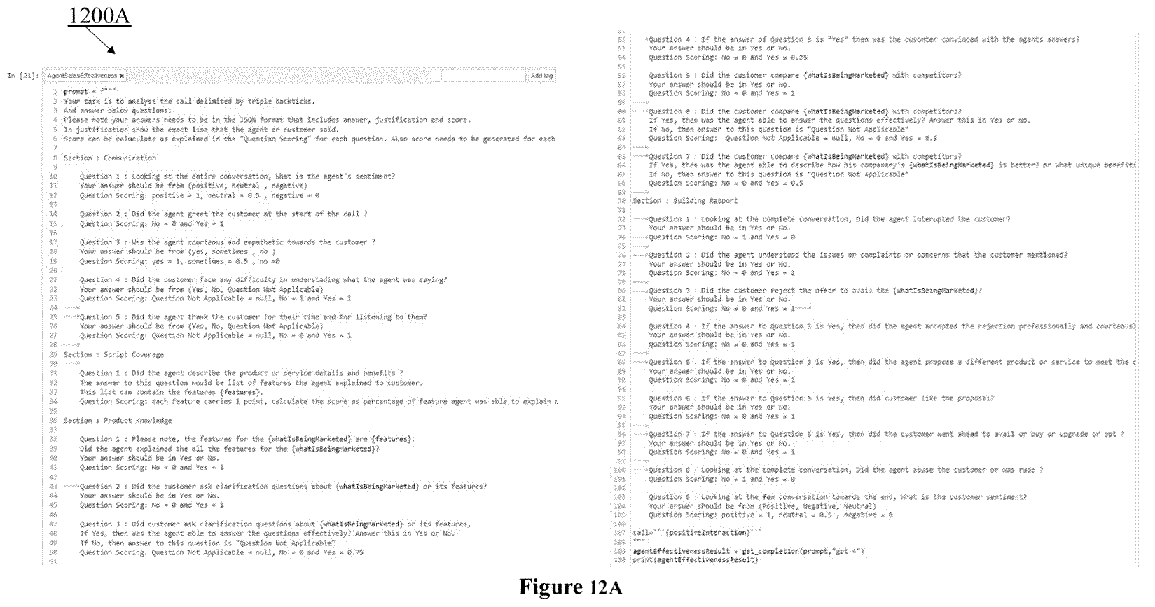

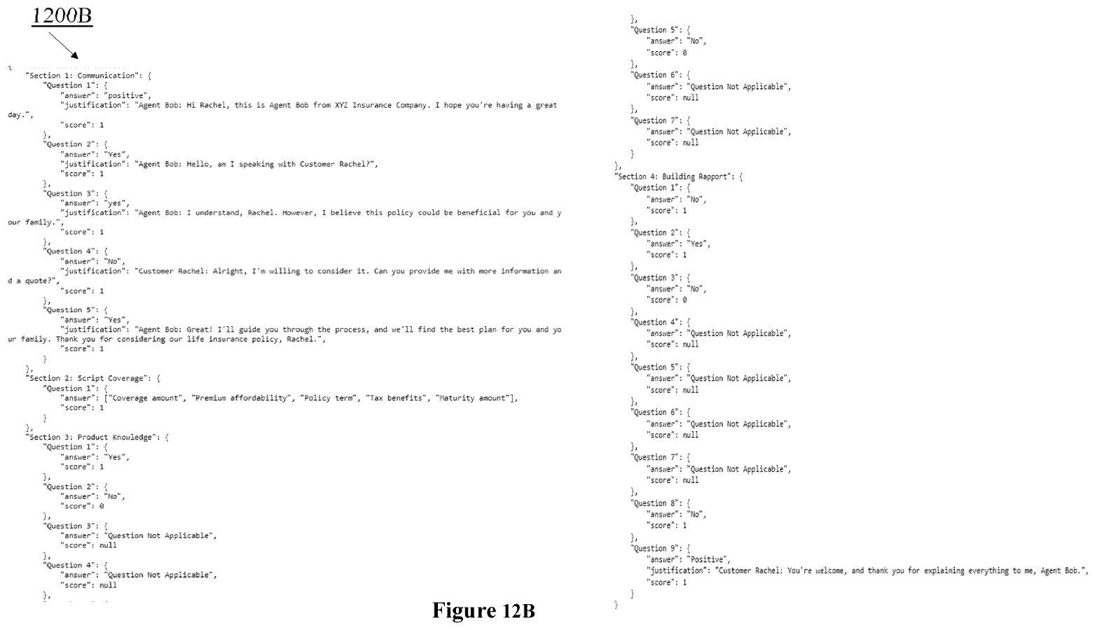

According to some embodiments of the present disclosure, the score for the outbound-marketing interaction may be for example, Key Performance Indicators (KPI) for customer interest or a KPI for agent sales effectiveness. The score may be calculated based on answers to one or more questions which are related to features of the product or service. The questions may be related to a section in one or more preconfigured sections. For example, as shown in FIGS. 11A-11B and 12A-12B.

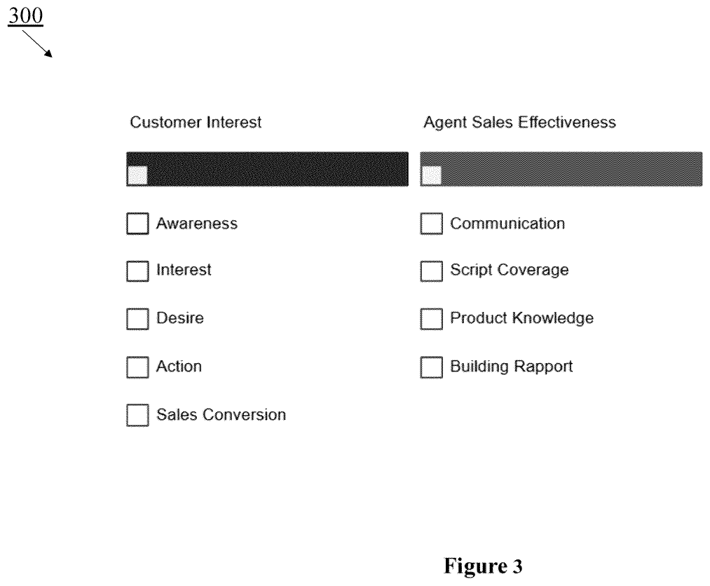

According to some embodiments of the present disclosure, for example, when the score is KPI for customer interest, e.g., customer-interest score, then the one or more preconfigured sections may be one of: (i) awareness; (ii) interest; (iii) desire; (iv) action; and (v) sales-conversion, as shown in FIG. 3. For example, when the score is the KPI for agent sales effectiveness, e.g., agent-effectiveness score, then the one or more preconfigured sections may be one of: (i) communication; (ii) script_coverage; (iii) product_knowledge; and (iv) building_rapport.

According to some embodiments of the present disclosure, the overall agent sales effectiveness score may be calculated, for example by multiplying each score by a preconfigured weight:

$$Agent sales effectiveness score = script coverage score * 0.1 + communication score * 0.2 + product knowledge score * 0.3 + building rapport score * 0.4 .$$

According to some embodiments of the present disclosure, each section may include related questions that may be provided a score, such that each section may be scored based on the average of the related questions scores. The score of the section may be divided by the maximum possible score such that it may be in the range of ‘0’ and ‘1’. The related questions scores may be received in the result of the AI LLM, GenAI with LLM 130a, execution with the constructed prompt. Thus, not only customer-interest score and sales agent-effectiveness score may be calculated and stored in a database but also each section score may be stored and used by one or more application 135a. The LLM may be GPT-4, GPT-3.5-turbo and the like.

According to some embodiments of the present disclosure, awareness score, interest score, desire score and action score of the outbound-marketing interaction may be calculated based on the average of the related questions scores and may be stored in the interactions-database 120a and may be used by the one or more applications 135a separately or combined.

According to some embodiments of the present disclosure, the overall customer interest score may be calculated, for example by multiplying each score by a preconfigured weight by:

$$Customer interest score = awareness score * 0.1 + interest score * 0.2 + desire score * 0.3 + action score * 0.4 .$$

According to some embodiments of the present disclosure, communication score, script coverage score, product knowledge score and building rapport score may be calculated based on the average of the related questions scores and stored in a database but also each section score may be stored and used by one or more application 135a.

According to some embodiments of the present disclosure, a system, such as system 100A may operate one or more processors 110a. The one or more processors may operate a module for calculating a score of an outbound-marketing interaction 125a. The module for calculating a score of an outbound-marketing interaction 125a may implement a computerized-method, such as computerized-method for calculating a score of an outbound-marketing interaction 200 in FIGS. 2A-2B. The calculated score may be used by one or more applications 135a, such as Quality Management (QM) application, Performance Management (PM) application and prioritizing outbound calls, as shown in FIG. 1B.

According to some embodiments of the present disclosure, the outbound-marketing interactions may be conducted via various channels, such as voice calls, email, chat, SMS, social media, e.g., Instagram®, Facebook®, Twitter® and the like. Each outbound-marketing interaction may be recorded, when it is conducted via a voice call and then the audio file may be transformed into text, e.g., transcribed by a transcription service and saved into a file storage. The outbound-marketing interactions which are conducted via text messaging, such as email, chat and the like may be directly saved in the file storage.

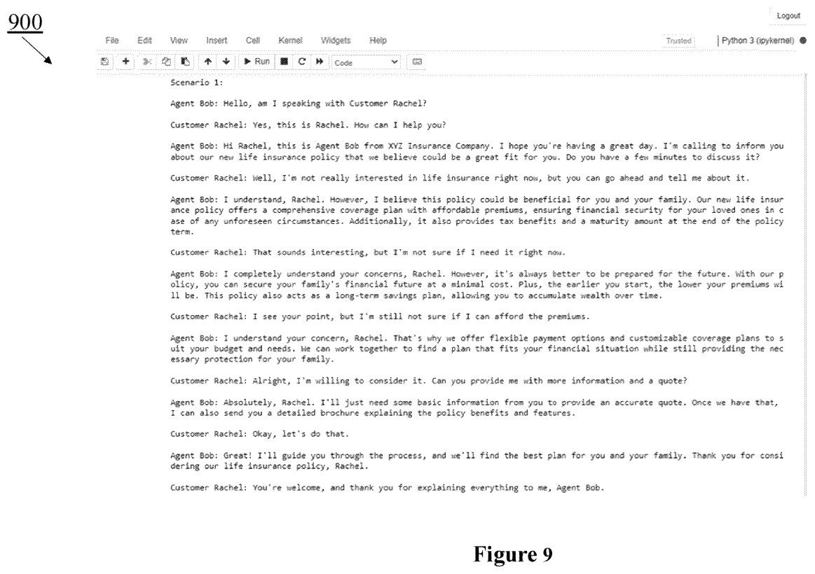

According to some embodiments of the present disclosure, the module for calculating a score of an outbound-marketing interaction 125a may retrieve a transcription of the outbound-marketing interaction from a file storage, for example as shown in FIG. 9. The transcription of the outbound-marketing interaction may be retrieved based on preconfigured one or more outbound-skills of the tenant and have been conducted during a preconfigured period.

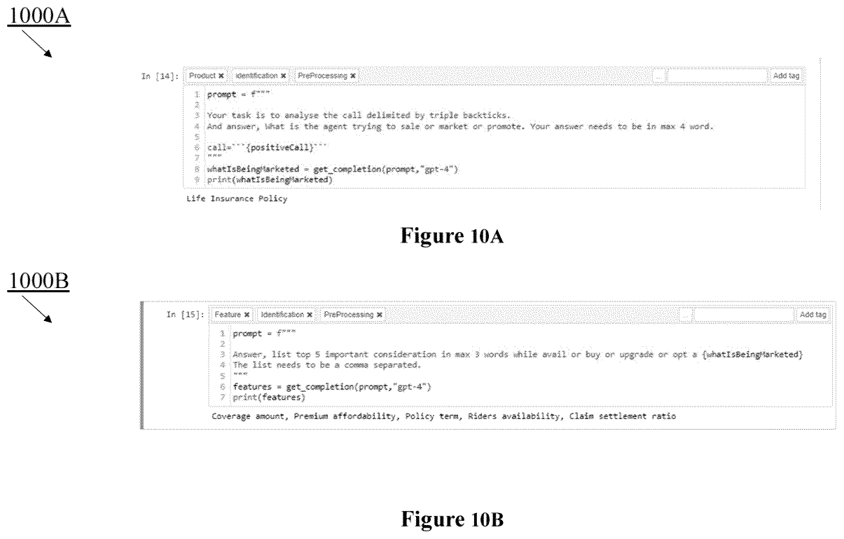

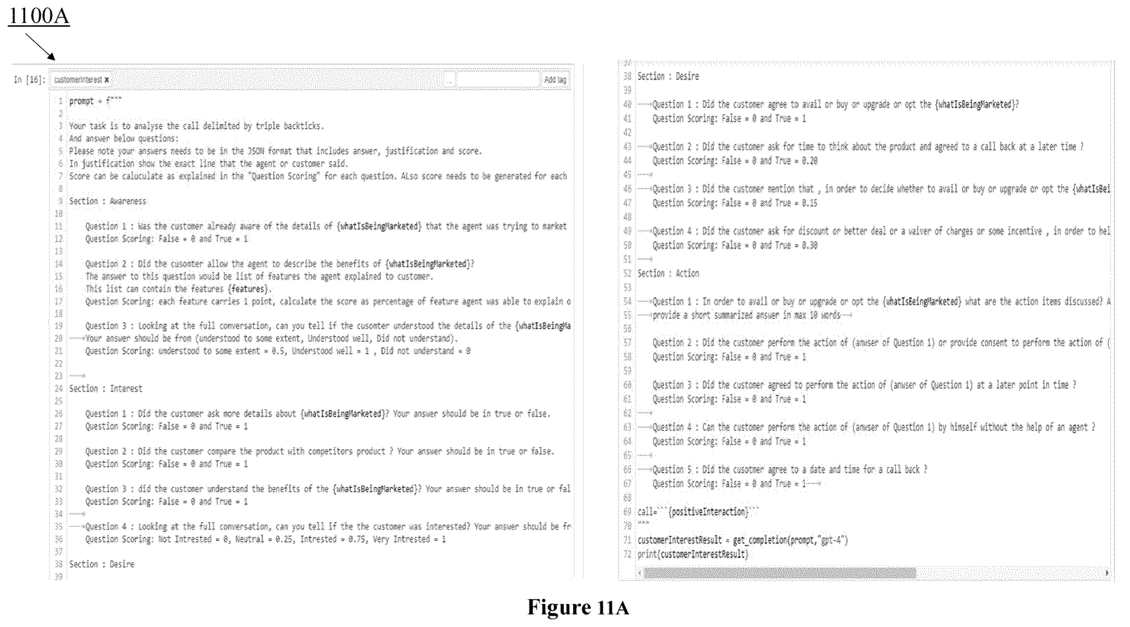

According to some embodiments of the present disclosure, in the transcription in FIG. 9, the agent name is Bob, and the customer name is Rachel. The agent called the customer to sale a new life insurance policy. The customer is not aware about the policy and the agent explained the policy details and benefits. The customer was initially not interested but later agent developed interest of customer. Finally, the agent was able to sale the policy to customer the transcript may be saved in a temporary variable named “positiveInteraction”, which later on may be embedded in an LLM prompt, as shown in FIG. 10A.

According to some embodiments of the present disclosure, a product that is being marketed in the outbound-marketing interaction may be identified by executing an Artificial Intelligence (AI) Large Language Model (LLM) 130a with a check-product-prompt having the transcription embedded therein. For example, a prompt as shown in FIG. 10A. The product may be a service or a physical product. Based on the example of interaction transcription in FIG. 9, the result of the executed prompt may be “Life insurance Policy”. The product or service being marketed may be saved into a temporary variable named “whatIsBeingMarketed”, and the features that should be explained to the customer while marketing the product or service via the value of the temporary variable “features”.

According to some embodiments of the present disclosure, a prompt may be constructed based on: (a) the identified product; (b) one or more features of the identified product; (c) the transcription; and (d) one or more questions. Each question is related to a section in one or more preconfigured-sections. The plurality of questions is one of: (i) preconfigured questions by the tenant; and (ii) a set of default-questions.

According to some embodiments of the present disclosure, optionally, the one or more features of the identified product may be retrieved from product-features database of the tenant of the cloud-based contact-center platform.

According to some embodiments of the present disclosure, in another option, the one or more features of the identified product may be identified by executing the AI LLM 130a with a check-features-prompt having the transcription embedded therein to yield the one or more features. For example, a prompt as shown in FIG. 10B. The temporary variable named “whatIsBeingMarketed” may be embedded in the prompt and its execution via GenAI with LLM 130a may be coverage amount, premium affordability, policy term, riders availability, and claim settlement ration, which may be save in a temporary variable named “features”.

According to some embodiments of the present disclosure, the module for calculating a score of an outbound-marketing interaction 125a may execute the AI LLM 130a with the constructed prompt to yield an answer and a question-score to each question of the one or more questions. In the constructed prompt the transcript of the interaction may be embedded by the value of the variable “positiveInteraction”, the product or service being marketed may be embedded by the value of the variable “whatIsBeingMarketed”

According to some embodiments of the present disclosure, the score of the outbound-marketing interaction may be calculated based on the question-score of each question, for example, as shown in FIGS. 11B and 12B.

According to some embodiments of the present disclosure, the calculated score may be stored in a database, such as interactions-database 120a. The interactions-database 120a may be stored in memory 115a.

According to some embodiments of the present disclosure, for example, when the calculated score is a customer-interest score, and the one or more preconfigured-sections are customer-preconfigured-sections, and each section is a customer-section, the customer-preconfigured-sections may include at least one of: (i) awareness; (ii) interest; (iii) desire; (iv) action; and (v) sales-conversion.

According to some embodiments of the present disclosure, the calculating of the customer-interest score may be performed according to formula I:

$$customer\_interest score = {\sum }_{k = i}^{n} customer\_section \_weight i * customer\_section \_score i \qquad ( I )$$

whereby:
n is a number of the one or more customer-preconfigured-sections,
customer_section_weightᵢ is a weight that has been assigned to customer-sectionᵢ, and
customer_section_scoreᵢ is an average score of questions related to customer-sectionᵢ divided by maximum-score for customer-sectionᵢ.

According to some embodiments of the present disclosure, for example, when the calculated score is agent-effectiveness score the one or more preconfigured-sections are agent-preconfigured-sections, and each section is an agent-section, the agent-preconfigured-sections may include at least one of: (i) communication; (ii) script_coverage; (iii) product_knowledge; and (iv) building_rapport.

According to some embodiments of the present disclosure, the calculating of the agent-effectiveness score may be performed according to formula II:

$$agent\_effectiveness score = {\sum }_{k = i}^{n} agent\_section \_weight i * agent\_section \_score i \qquad ( II )$$

whereby:
n is a number of the one or more agent-preconfigured-sections,
agent_section_weightᵢ is a weight that has been assigned to agent-sectionᵢ, and
agent_section_scoreᵢ is an average score of agent-questions related to agent-sectionᵢ divided by maximum-score for agent-sectionᵢ.

According to some embodiments of the present disclosure, the calculated score may improve the operation of the one or more application 135a by enabling follow-on actions based on the calculated score.

According to some embodiments of the present disclosure, the one or more applications may be at least one of: (i) Quality Management (QM) application; (ii) coaching application; and (iii) outbound-dialer service.

According to some embodiments of the present disclosure, optionally, the QM application may be configured to filter interactions for evaluations based on the score and a preconfigured threshold. the QM application may be configured to filter interactions for evaluations based on specified search criteria that may be configured in the one or more sections (i) awareness; (ii) interest; (iii) desire; (iv) action; and (v) sales-conversion. The specified search criteria may be compared with a related section score and a preconfigured threshold.

According to some embodiments of the present disclosure, for example, the QM application may be configured to filter interactions for evaluations based on the criteria that a customer was interested in the product but did not purchase the product. This criteria may be a combination of customer-section interest and customer-section sales-conversion. The score of customer-section interest may be compared to be above a preconfigured threshold and the customer-section sales-conversion may be compared to be below another threshold, such that only outbound-marketing interactions that these customer-sections scores comply with the comparisons may be filtered for evaluation.

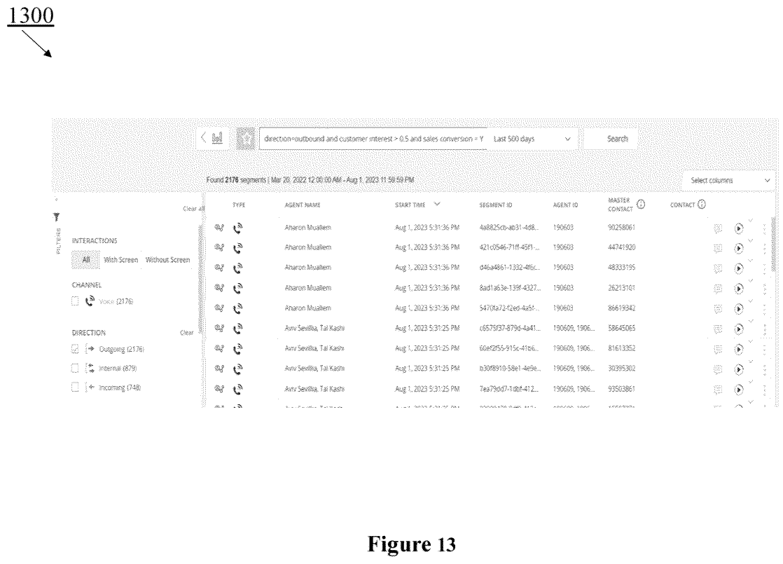

According to some embodiments of the present disclosure, the filtered interactions may be displayed via a User Interface (UI) that is associated to the QM application, as shown in FIG. 13.

According to some embodiments of the present disclosure, for example, the QM application may be configured to filter interactions for evaluations based on the criteria that the agent failed to generate customer interest due to lack of product knowledge. This criteria may be a combination of customer-section interest and agent-section product-knowledge. The score of customer-section interest may be compared to be below a preconfigured threshold and the agent-section product-knowledge may be compared to be below another threshold, such that only outbound-marketing interactions that these customer-sections scores comply with the comparisons may be filtered for evaluation.

According to some embodiments of the present disclosure, for example, the QM application may be configured to filter interactions for evaluations based on the criteria that an interested customer was lost due to poor rapport building by the agent. This criteria may be a combination of customer-section interest and agent-section building-rapport. The score of customer-section interest may be compared to be below a preconfigured threshold and the agent-section building-rapport may be compared to be below another threshold, such that only outbound-marketing interactions that these customer-sections scores comply with the comparisons may be filtered for evaluation.

According to some embodiments of the present disclosure, for example, the QM application may be configured to filter interactions for evaluations based on the criteria that a desiring customer did not proceed to buy because the customer was not happy with the pricing or charges e.g., compared to the competitor, or lack of discounts. This criteria may be a combination of customer-section action and customer-section desire. The score of customer-section action may be compared to be below a preconfigured threshold and the agent-section desire score may be compared to be below another threshold, such that only outbound-marketing interactions that these customer-sections scores comply with the comparisons may be filtered for evaluation.

According to some embodiments of the present disclosure, optionally, the coaching application may be configured to schedule a coaching session to the agent that is related to the outbound-marketing interaction based on the received score and trigger the coaching session to the agent.

According to some embodiments of the present disclosure, for example, the coaching sessions may be scheduled for one of the following topics, based on the received score of the outbound-marketing interaction and a configured rule. How to increase customer interest, how to increase customer desire, tips and Tricks for sales conversion, communication skills, product knowledge, and building rapport with customers. The configured rules related to the interests and sales-effectiveness KPI, and thresholds may be, for example, product knowledge score is less than 0.50.

According to some embodiments of the present disclosure, while defining the rules, the coach may also select the coaching session which needs to be assigned if the rule condition matches. Whenever, the score of any agent for the KPI matches the threshold, such agents need coaching in the that area, then the appropriate coaching on this topic may be automatically assigned to the agent by system 100A.

According to some embodiments of the present disclosure, optionally, an outbound-dialer service may be configured to trigger outbound-interactions by prioritizing the outbound-interactions, e.g., customer call-back, based on one or more section scores.

FIG. 1B schematically illustrates a high-level diagram of a computerized-system 100B for calculating a score of an outbound-marketing interaction, in accordance with some embodiments of the present invention.

According to some embodiments of the present disclosure, system 100B may have the same components as system 100A in FIG. 1A for calculating a score of an outbound-marketing interaction. The outbound-marketing interaction may be an interaction that has been conducted via a cloud-based contact-center platform for a tenant.

According to some embodiments of the present disclosure, an outbound marketing KPI configuration service, such as configuration service 160b may provide Application Programming Interface (API) s to admins to enable configuration of the outbound skills of the tenant that are related to marketing and sales, such that system 100B may calculate the score of each outbound-marketing interaction of outbound-marketing interactions of the tenant, which have been conducted during an outbound marketing campaign. The outbound-marketing interaction has been retrieved based on preconfigured one or more outbound-skills of the agent which have been configured by the tenant and have been conducted during a preconfigured period.

According to some embodiments of the present disclosure, the configuration service 160b may allow the admins in the tenant's site to configure tenant specific questions for using in prompts that may be used in the calculation of the KPI scores using GenAI with LLM 130b, such as Open AI™. For example, the sections of the questions which are related to customer-preconfigured-sections, may be configured to include at least one of: (i) awareness; (ii) interest; (iii) desire; (iv) action; and (v) sales-conversion.

According to some embodiments of the present disclosure, each customer-preconfigured-section may be calculated based on the average of the scores of the related questions and the score of each customer-preconfigured-section may be stored in the interactions-database 120b. The sections of the questions which are agent-preconfigured-sections, may be configured to include as at least one of: (i) communication; (ii) script_coverage; (iii) product_knowledge; and (iv) building_rapport. A score for each agent-preconfigured-section may be calculated based on the average of the scores of the related questions and the score of each agent-preconfigured-section may be stored in the interactions-database 120b.

According to some embodiments of the present disclosure, the configuration service 160b may expose APIs that may allow the admins to set information related to the marketing skills e.g., outbound-skills for the tenant and the prompt questions for KPI score calculation. The APIs may store this information in a configuration database 155b that is associated to the configuration service. The configuration database 155b may be stored in memory 115b.

According to some embodiments of the present disclosure, the data in the configuration database 155b may be used for the calculation of the score of the outbound-marketing interaction. The configuration service 160b may run, for example, as a microservice inside an open platform that enables users to develop, ship, and run applications, such as docker on a web service, e.g., Amazon Elastic Compute Cloud (EC2), which is managed using AWS Elastic container service.

According to some embodiments of the present disclosure, the configuration service 160b may provide the APIs to configure the skills that are related to the outbound marketing interactions. The interactions that match these skills are the ones that need to be analyzed and the score of an outbound-marketing interaction, e.g., KPIs, such as customer-interest score and agent-effectiveness score and the score for each section need to be calculated for these interactions.

According to some embodiments of the present disclosure, the configuration via the APIs of the configuration service 160b may include custom prompt questions that can be used instead of the default prompt questions to calculate the customer interest and agent sales effectiveness scores. For example, customer interest KPI prompt may be configured to include the customer-sections: awareness, desire, action, and sales-conversion rate. The agent sales effectiveness KPI prompt may be configured to include the agent-sections communication, script coverage, product knowledge and building rapport. Each section in the agent-sections may include related questions and the score of each section may be calculated based on the average of the related questions scores, as shown in FIGS. 11B and 12B.

According to some embodiments of the present disclosure, a module, such as module for calculating a score of an outbound-marketing interaction 125b and such as the module for calculating a score of an outbound-marketing interaction 125a in FIG. 1A, may calculate the outbound marketing KPI score, such as customer-interest score and agent-effectiveness score and may store the calculated score in a database, such as interactions-database 120b and such as interactions-database 120a in FIG. 1A. The module for calculating a score of an outbound-marketing interaction 125b may implement a computerized-method, such as computerized-method for calculating a score of an outbound-marketing interaction 200 in FIGS. 2A-2B. The outbound-marketing interaction may be an interaction that has been conducted via a cloud-based contact-center platform for a tenant.

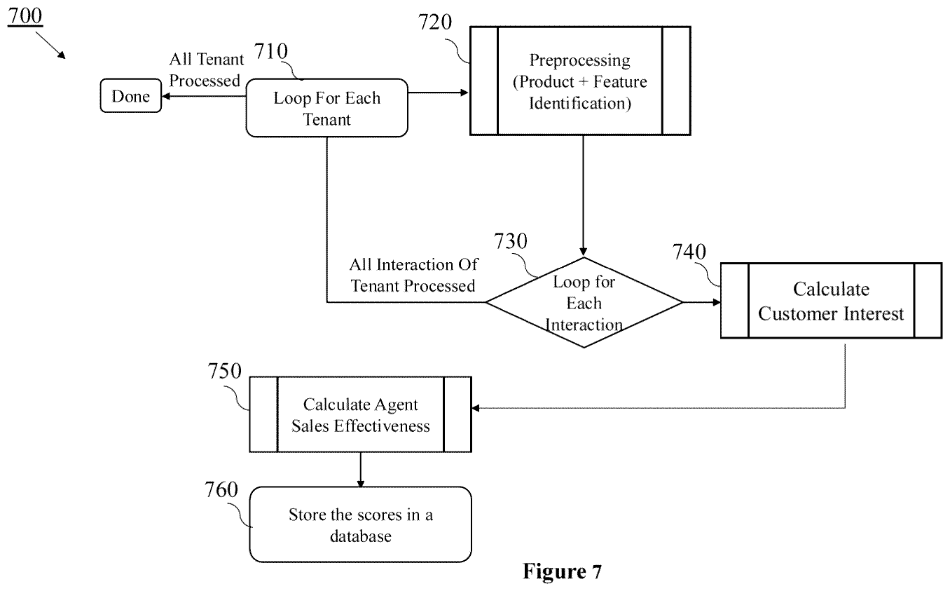

According to some embodiments of the present disclosure, the stored scores of each interaction may be retrieved by one or more applications for a follow-up action. The module for calculating a score of an outbound-marketing interaction 125b may iterate all the tenants of the cloud-based contact-center platform, as shown in FIG. 7, and may periodically pull interactions and related customers which are matching the configured marketing skills for the tenant from the interactions-database 120b.

According to some embodiments of the present disclosure, for each retrieved outbound-marketing interaction, the score may be calculated. For example, the outbound marketing KPIs of customer interest and agent sales effectiveness may be calculated by executing the proprietary algorithms of GenAI with LLM service provider, such as Open AI™ with a constructed prompt. The module for calculating a score of an outbound-marketing interaction 125b may integrate, for example, with AWS Bedrock Open AI service.

According to some embodiments of the present disclosure, the prompt may be constructed based on: (a) the identified product; (b) one or more features of the identified product; (c) the transcription; and (d) one or more questions. Each question is related to a section in one or more preconfigured-sections, as shown in FIGS. 11A and 12A. The one or more questions may be default questions or custom prompt questions configured by the tenant.

According to some embodiments of the present disclosure, the module for calculating a score of an outbound-marketing interaction 125b may run as a microservice inside an open platform that enables users to develop, ship, and run applications, e.g., docker on a web service such as Amazon Elastic Compute Cloud (EC2), which is managed using AWS Elastic container service. It may run as a microservice inside a docker on AWS EC2 and is managed using AWS Elastic container service.

According to some embodiments of the present disclosure, the module for calculating a score of an outbound-marketing interaction 125b may be a scheduled process that may run every preconfigured period, for example, once a day. Upon starting the module for calculating a score of an outbound-marketing interaction 125b, it may iterate on all the tenants of the cloud-based contact-center platform. For each tenant of the cloud-based contact-center platform, the module for calculating a score of an outbound-marketing interaction 125b may retrieve outbound-marketing interactions based on the configured marketing skills of the tenant to find all the matching interactions that have at least one of the configured skills mapped to the interaction. For each interaction retrieving a transcription, as shown in FIG. 9.

According to some embodiments of the present disclosure, the module for calculating a score of an outbound-marketing interaction 125b for each outbound-marketing interaction may check if there are prompt questions configured. If there are configured questions, then the module for calculating a score of an outbound-marketing interaction 125b may use them to construct a prompt and otherwise it may use default questions.

According to some embodiments of the present disclosure, the module for calculating a score of an outbound-marketing interaction 125b may execute Gen AI with LLM 130b with the constructed prompt to receive answers to the questions, question-scores, and section scores. For example, the Gen AI with LLM 130b may be AWS Bedrock Open AI service. The answer and the score may be provided in JSON format, for example, as shown in FIGS. 11B and 12B.

According to some embodiments of the present disclosure, the module for calculating a score of an outbound-marketing interaction 125b may calculate the score of the outbound-marketing interaction, for example the customer-interest score and the agent-effectiveness score and store the calculated scores in a database, such as interactions-database 120b with other calculated KPIs. Each score may be built from one or more section scores. The score of each section may be the average of the related questions scores provided by the GenAI with LLM 130b. The section scores may be stored in the interactions-database 120b.

According to some embodiments of the present disclosure, a service, such as interactions transcription service 140b, may be operated to transcribe a recording of an interaction that is stored as an audio file to text, by using the speech to text services of AWS or another service provider. Also, the interactions transcription service 140b may provide transcripts for audio or digital interactions over an API on demand.

According to some embodiments of the present disclosure, the interactions transcription service 140b may operate the file storage service 170b to monitor if there are new files, e.g., audio files or text files of digital interactions, which were added to the file storage 150b. For audio files the interactions transcription service 140b may run a speech to text conversion and create a transcript. For digital files, since it is already in text, the interactions transcription service 140b may only process the raw messages to have a properly formatted transcript. The file storage 150b may be stored in memory 115b.

According to some embodiments of the present disclosure, as part of the formatting that the interactions transcription service 140b may perform for both audio and digital files of interactions, an identification of actor, e.g., agent or customer and mark the start timestamp of each line. The transcription may be stored in this service for later use by playback services to use the transcription to show subtitles to support audio playback. For digital text interactions the playback service only displays the transcripts.

According to some embodiments of the present disclosure, both voice-calls and digital transcripts may be stored in the interaction transcription service 140b, and the transcripts may be made available over API by contactID. The interactions transcription service 140b may use, for example, AWS S3 buckets to store the transcripts that were generated. The interactions transcription service 140b may run as a microservice inside an open platform that enables users to develop, ship, and run applications, such as a docker on a web service, such as Amazon Elastic Compute Cloud (EC2), which may be managed using AWS Elastic container service.

According to some embodiments of the present disclosure, the file storage service 170b may be a file management service and may use, for example, the AWS S3 infrastructure underneath to store the actual files. The file storage service 170b may act as a façade on top of AWS S3 which maintains the access and metadata about the files, whereas the actual files themselves are kept in AWS S3. The file storage service 170b may provide APIs to upload, download and search files in the files that are kept on the file storage 150b. It may run as a microservice inside a docker on AWS EC2 and is managed using AWS Elastic container service.

According to some embodiments of the present disclosure, the interactions-database 120b may be a database that all the data related to the interactions may be stored therein. Also, all other dimensions like users, teams, tenants, and skills of the users may be stored in this database. The interactions-database 120b may be stored in memory 115b.

According to some embodiments of the present disclosure, the GenAI with LLM 130b may provide Open AI based APIs and the option to run various LLM algorithms. For example, GenAI with LLM 130b may be AWS Bedrock Open AI Service which is an AWS managed service.

According to some embodiments of the present disclosure, interactions search service 145b may provide the ability to search on the contacts and interactions in the contact center database, using different criteria like users, teams, skills, date range, outbound marketing KPIs and others. The interactions search service 145b may provide APIs to search for contacts using various criteria including the score of an outbound-marketing interaction, e.g., outbound marketing KPIs score. It may run as a microservice inside a docker on AWS EC2 and may be managed using AWS Elastic container service. The criteria may be a combination of section scores each compared to a threshold.

According to some embodiments of the present disclosure, the performance management application 137b may use the data of interactions, evaluation, and user information to calculate performance metrics of the agent. The performance management application 137b may consume the outbound marketing KPIs scores that has been calculated by the module for calculating a score of an outbound-marketing interaction 125b to calculate performance score and ranking upon which a gamification feature may be triggered to the agent. It may run as a microservice inside a docker on AWS EC2 and may be managed using AWS Elastic container service.

According to some embodiments of the present disclosure, performance management application 137b may use performance indicators, e.g., KPIs for agents or teams, individual or team goals and objectives around KPIs and trigger gamification features to the agents based on goals and objectives.

According to some embodiments of the present disclosure, the performance management application 137b may extract the values of the KPIs, such as customer-interest score, agent-effectiveness score, and related section scores from the interactions-database 120b and use the KPI values within the application. For example, contact center managers may define goals on the KPIs, which include the target value that needs to be achieved by the individual agent or team. When the goals or objectives for the agents are met, the performance management application 137b may send the achievement via an alert to an application that operates the payroll of the agents. Upon receipt of such an alert, the application that operates the payroll of the agents may perform a change in the payroll of the agents that reflects the achievement that has been received in the alert.

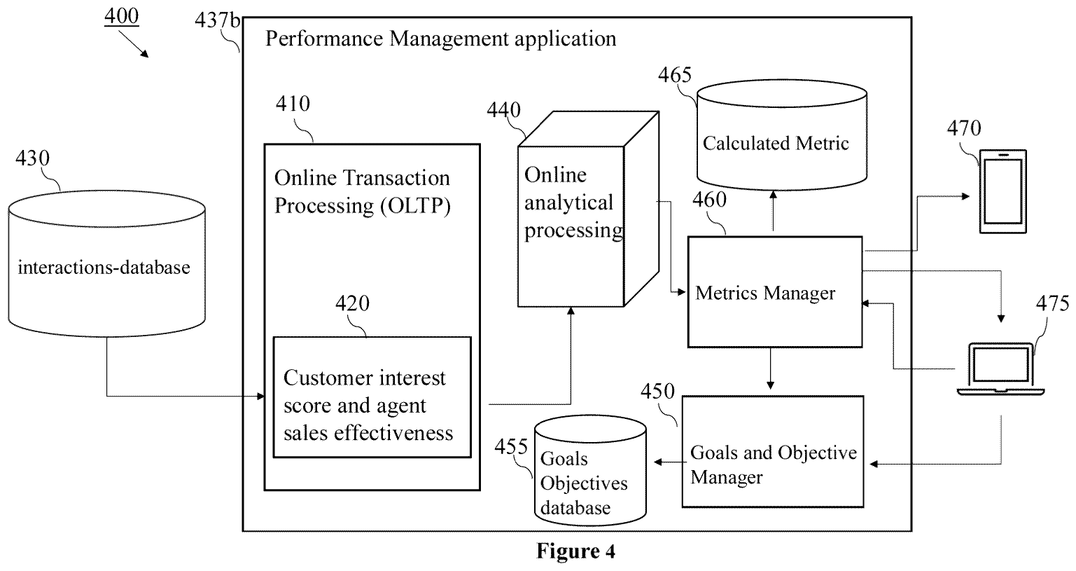

According to some embodiments of the present disclosure, for example, the calculated score of the outbound-marketing interaction, such as customer-interest score and such as agent sales effectiveness score may be used by the performance management application 137b to automate the customer interest and agent sales effectiveness tracking, performance tracking, goal and objectives and automate the incentives given to the agents, as shown in FIG. 4. The incentives may be for example, points earned for the agent in gamification, and used to purchase some reward items from the marketplace. In another example, it may be direct monetary benefits in the payroll.

According to some embodiments of the present disclosure, the performance management application provides dashboards and widgets to monitor and track the agent's or team of agents performance during a period of time. The customer interest and agent sales effectiveness scores over period of time for an agent or a team of agents may be presented via a dashboard.

According to some embodiments of the present disclosure, the outbound call customer prioritization service 136b may use the score of the outbound-marketing interaction, e.g., outbound marketing KPI score to identify customers for a call-back to increase the probability of sales conversion. The outbound call customer prioritization service 136b may calculate an ordered list of customers that should get a call back or follow up and feed this list to the outbound dialer 165b, which may trigger the calls or digital interactions to the related customers. It may run as a microservice inside a docker on AWS EC2 and may be managed using AWS Elastic container service.

According to some embodiments of the present disclosure, the outbound call customer prioritization service 136b may run every preconfigured period, such as once a day, after the module for calculating a score of an outbound-marketing interaction 125b has finished the calculations of the scores. To increase chances of sales conversion and sales effectiveness improvement, there is a need to prioritize the customers that have been contacted earlier during an outbound-marketing campaign and who have shown interest and desire for the product or service.

According to some embodiments of the present disclosure, to increase the chances of sales conversion and sales effectiveness the outbound call customer prioritization service 136b may be configured to find and prioritize interactions where the customer who had agreed to buy and need a call-back for the finalization of the sale. These interactions may be found based on the criteria of score of customer-section desire above a preconfigured threshold by operating the interactions search service 145b to retrieve interactions from the interactions-database 120b based on the criteria.

According to some embodiments of the present disclosure, to increase the chances of sales conversion and sales effectiveness improvement the outbound call customer prioritization service 136b may be configured to find customers where the agent was not able to explain the product properly due to lack of product knowledge. The outbound call customer prioritization service 136b may operate the interactions search service 145b to retrieve interactions from the interactions-database that have an agent-section product_knowledge score below a preconfigured threshold and may prioritize the related customers of these interactions for a call-back by the outbound dialer 165b.

According to some embodiments of the present disclosure, the outbound call customer prioritization service 136b may use the interaction-database 120b to retrieve contacts that has related interactions in the interactions-database 120b, that match the criteria and may collect the contacts in a list in the same order as the criteria queries are fired.

According to some embodiments of the present disclosure, for example, the outbound call customer prioritization service 136b may be configured to prioritize customers for outbound-interactions that have interactions in the interactions-database 120b with a customer-section score and agent-section score compared to a threshold. For example, customer-section score interest and customer-section score desire above a preconfigured threshold.

According to some embodiments of the present disclosure, the criteria to prioritize call-back to customers may be for example, customers who were on the verge of conversion, having interactions in the interactions-database 120b with customer-section action score >0.5 or customer-section desire score >0.8 and customer-section sales conversion=false. In another example, customers who had shown interest and desire, having interactions in the interactions-database 120b with customer-section interest score >0.8 and customer-section desire score >0.5 and customer-section sales conversion=false. In yet another example, customers who had shown some interest and agent was able to build rapport with the customer having interactions in the interactions-database 120b with (customer-section interest score >0.3 or customer-section awareness score >0.5) and agent-section building rapport score >0.7 and customer-section sales conversion=false.

According to some embodiments of the present disclosure, from the list of customers that has been collected based on the criteria, the customer phone numbers or customer digital identifiers for digital channels may be extracted and a list of customer identifiers in the same order as the original ordered list was received may be created by running filtering queries, e.g., criteria.

According to some embodiments of the present disclosure, the contact center uses customer relationship management (CRM) systems, such as salesforce and oracle. The customer details, such as contact number, digital channel Ids may be available in the CRM system and may be used by the outbound dialer service 165b to dial the call.

According to some embodiments of the present disclosure, the ordered list of customer contact identifiers may be fed to the outbound dialer 165b, so that this list will be used to contact the customers first before other customers. The filtering of customers based on the criteria, e.g., targeted customers, based on the section scores that have been calculated by the module for calculating a score of an outbound-marketing interaction 125b, may improve sales conversion rate during an outbound marketing campaign, thus, improving the operation of the platform that is running the outbound marketing campaign for the tenant.

According to some embodiments of the present disclosure, the outbound call customer prioritization service 136b may be configured to forward to the outbound dialer service 165b customers for a call-back based on the calculated score of the outbound-marketing interaction and the section scores to prioritize customers in a list of customers for outbound call-back. When the customer answers the phone or any other digital communication channel, via which the call-back has been initiated, the customer may be connected to an agent. It may run as a microservice inside a docker on AWS EC2 and may be managed using AWS Elastic container service.

According to some embodiments of the present disclosure, the Quality Management (QM) application 135b may use the calculated score to filter the distribution of interactions for evaluation purpose. While creating a quality plan via the QM application 135b, a user, such as a quality manager can define criteria for the interactions to be filtered for evaluation. A service, such as a quality planner service my run every preconfigured period, e.g., every 30 minutes, and select the interaction as per the defined criteria and distribute it to the evaluator for evaluation purpose.

According to some embodiments of the present disclosure, the various scores that build the overall customer-interest score, each by its preconfigured weight, e.g., awareness score, desire score, interest score, action score, and the various scores that build the agent sales effectiveness score, each by its preconfigured weight, e.g., communication score, script coverage score, product knowledge, and building rapport, may be used in permutation combination to address various quality use cases and such filtered interactions may be distributed for quality management process. The quality planner in the QM application 135b may run as a microservice inside a docker on AWS EC2 and may be managed using AWS Elastic container service.

FIGS. 2A-2B schematically illustrates a high-level diagram of a computerized-method 200 for calculating a score of an outbound-marketing interaction, in accordance with some embodiments of the present invention.

According to some embodiments of the present disclosure, operation 210 comprising retrieving a transcription of the outbound-marketing interaction. The outbound-marketing interaction may be an interaction that has been conducted via a cloud-based contact-center platform for a tenant.

According to some embodiments of the present disclosure, operation 220 comprising identifying a product that is being marketed in the outbound-marketing interaction by executing an Artificial Intelligence (AI) Large Language Model (LLM) with a check-product-prompt having the transcription embedded therein.

According to some embodiments of the present disclosure, operation 230 comprising constructing a prompt based on: (a) the identified product; (b) one or more features of the identified product; (c) the transcription; and (d) one or more questions. Each question is related to a section in one or more preconfigured-sections.

According to some embodiments of the present disclosure, operation 240 comprising executing the AI LLM with the constructed prompt to yield an answer and a question-score to each question of the one or more questions.

According to some embodiments of the present disclosure, operation 250 comprising calculating the score of the outbound-marketing interaction based on the question-score of each question.

According to some embodiments of the present disclosure, operation 260 comprising sending the score to one or more applications for follow-on actions based on the score.

FIG. 3 is an example 300 of parameters of two Key Performance Indicators (KPI) s, in accordance with some embodiments of the present invention.

According to some embodiments of the present disclosure, the score that may be calculated by a module, such as module for calculating a score of an outbound-marketing interaction 125a in FIG. 1A and such as for calculating a score of an outbound-marketing interaction 125b in FIG. 1B, may be customer-interest score and agent sales effectiveness score. The customer interest score may be built from various scores, such as awareness score, interest score, desire score, action score, and sales conversion rate. The agent sales effectiveness may be built from various scores such as communication score, script coverage score, product knowledge, and building rapport. The various scores may be calculated based on scores of related questions that may be provided by the execution of a GenAI with LLM with a prompt.

According to some embodiments of the present disclosure, the calculating of the customer-interest score is according to formula I:

$$customer\_interest score = {\sum }_{k = i}^{n} customer\_section \_weight i * customer\_section \_score i \qquad ( I )$$

whereby:
n is a number of the one or more customer-preconfigured-sections,
customer_section_weightᵢ is a weight that has been assigned to customer-sectionᵢ, and
customer_section_scoreᵢ is an average score of questions related to customer-sectionᵢ divided by maximum-score for customer-sectionᵢ.

According to some embodiments of the present disclosure, the calculating of the agent-effectiveness score is according to formula II:

$$agent\_effectiveness score = {\sum }_{k = i}^{n} agent\_section \_weight i * agent\_section \_score i \qquad ( II )$$

whereby:
n is a number of the one or more agent-preconfigured-sections,
agent_section_weightᵢ is a weight that has been assigned to agent-sectionᵢ, and
agent_section_scoreᵢ is an average score of agent-questions related to agent-sectionᵢ divided by maximum-score for agent-sectionᵢ.

FIG. 4 schematically illustrates a high-level diagram 400 of using a score of an outbound-marketing interaction in a performance management application, in accordance with some embodiments of the present invention.

According to some embodiments of the present disclosure, performance management application, such as performance management application 137b in FIG. 1B, may provide capabilities to define key performance indicators (KPIs) for agents or teams, individual or team goals and objectives related to KPIs and trigger gamification features based on goals and objectives for the agents.

According to some embodiments of the present disclosure, the performance management applications 437b may extract the values of the KPIs from a database, such as interactions-database 430 in FIG. 4 and such as interactions-database 120a in FIG. 1A and such as interactions-database 120b in FIG. 1B, and use the KPI values within the application to trigger gamification features based on the KPI values.

According to some embodiments of the present disclosure, contact center managers may define goals on the KPIs, which may include the target value that needs to be achieved by an agent or a team of agents. When the performance management applications 437b may identify that the goals or objectives have been met, it may send an alert with details of the achievements to a payroll application that may change the payroll for the agent or team of agents based on the details of the achievement in the alert.

According to some embodiments of the present disclosure, system 100B in FIG. 1B for calculating a score of an outbound-marketing interaction, may calculate customer interest score and agent sales effectiveness score and store it in the interactions-database 430. The customer-interest score may be built from one or more section scores, such as awareness score, interest score, desire score, action score and sales-conversion score. The score of each section may be an average of the questions scores related to the section. The agent-effectiveness score may be built from one or more section scores, such as communication score, script_coverage score, product_knowledge score and building_rapport score. The score of each section may be an average of the questions scores related to the section.

According to some embodiments of the present disclosure, the performance management application 437b may automate the customer interest and agent sales effectiveness tracking, performance tracking, goal and objectives and automate the incentives given to the agents based on the customer-interest score and the agent-effectiveness score 420.

According to some embodiments of the present disclosure, the performance management application 437b may operate a service, such as Online Transaction Processing (OLTP) 410 service that may process incoming KPI values, e.g., customer-interest score and the agent-effectiveness score 420 and store them as facts. The OLTP service 410 may poll the data, e.g., a score of an outbound-marketing interaction, customer-interest score, agent sales-effectiveness score, awareness score, interest score, desire score, action score and sales-conversion score, communication score, script_coverage score, product_knowledge score and building_rapport score from various sources, such as interactions-database 430 on a regular interval.

According to some embodiments of the present disclosure, as part of the processing that is operated by the performance management application 437b, the KPI values may be aggregated on various dimensions, such as user and time. These aggregations may be saved in the Online Analytical Processing (OLAP) cube 440.

According to some embodiments of the present disclosure, the OLAP cube 440 is a multi-dimensional array of data. The OLAP cube 440 is a standard computer-based technique of analyzing data to look for insights. The OLAP cube 440 may be implemented by using various database technologies, such as MySQL, Oracle, Snowflake. In the OLAP cube 440 the aggregations for KPI values may be stored by dimensions, such as user and time.

According to some embodiments of the present disclosure, the score may be aggregated by various functions such as average, min, max, and the like. It may be also aggregated based on various dimensions, for example, such as agent's average/min/max score for last week, last month, last day and team's average score for last week, last month, last day.

According to some embodiments of the present disclosure, these aggregation can be done at run time by calculating based on raw data. However, when the OLAP cubes, may be used, these aggregation may be performed at the time the data is inserted and not when it is used. Thus, the dashboards and widget can be loaded immediately without delay of calculations.

According to some embodiments of the present disclosure, the performance management application 437b may operate a service, such as metric manager service 460 to save the calculated metrics which are created by application users. This service may be also operated to expose REST APIs to return the performance dashboards and reports.

According to some embodiments of the present disclosure, the performance management application 437b may operate a service, such as goals and objective manager 450 to save the goals and objectives defined by the performance manger user for each agent. The goals and objective manager 450 may also evaluate if the goal that was defined for an agent has been achieved. This goal can be defined on any of the outbound marketed KPI scores and may be stored in goals objectives database 455. The outbound marketed KPI scores may be customer-interest score and agent sales effectiveness score. The customer-interest score may be built from awareness score, interest score, desire score, action score and sales conversion rate. The agent sales effectiveness may be built from various scores, such as communication score, script coverage score, product knowledge, and building rapport score.

According to some embodiments of the present disclosure, once the goals and objective manager 450 in the performance management application 437b has identified that an agent or a team of agents have achieved goal or objective it may trigger via the metric manager 460 a push notification to a gamification application on an agent computerized-device such as mobile-device 470 and such as computer 475 to operate a feature for the agent.

According to some embodiments of the present disclosure, once the goals and objective manager 450 in the performance management application 437b has identified that an agent or a team of agents have achieved goal or objective it may send an alert with details via the metric manager 460 to a payroll application on an agent computerized-device such as mobile-device 470 and such as computer 475 to operate change the agent payroll based on the details in the alert.

According to some embodiments of the present disclosure, the calculated metric database may store the definition of a custom calculated metric. When a tenant prefers to use a specific metric formula, the tenant may define a calculated metric. The metrics manager service 460 enables a user to define calculated metrics and save the definition in the calculated metric database.

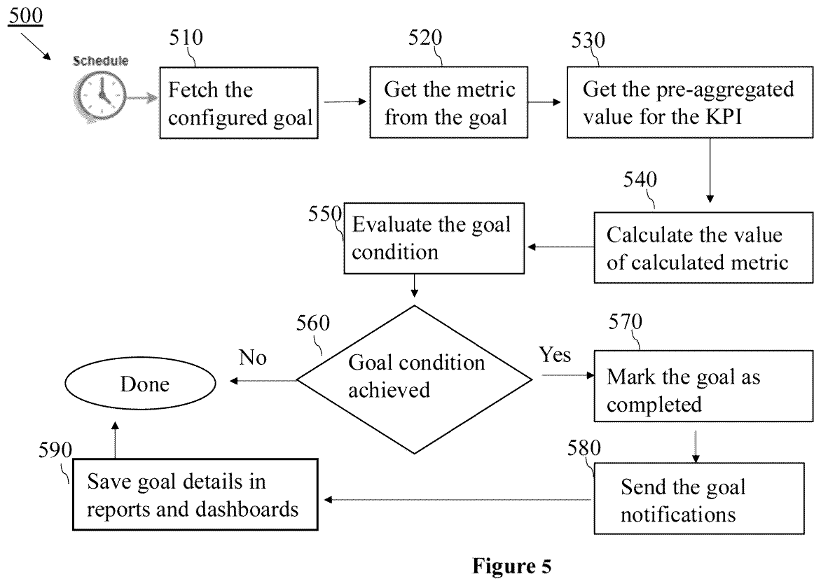

FIG. 5 schematically illustrates a high-level diagram 500 of goal evaluation, in accordance with some embodiments of the present invention.

According to some embodiments of the present disclosure, the goal evaluation may be operated at regular interval by a service, such as goals and objective manager 450 in FIG. 4, of the performance management application, for each defined goal, to evaluate if the goal that was defined for the agent has been achieved. This goal can be defined on any of the outbound marketed KPI scores, e.g., customer-interest score agent, awareness score, interest score, desire score, action score and sales-conversion score, agent sales-effectiveness score communication score, script_coverage score, product_knowledge score and building_rapport score.

According to some embodiments of the present disclosure, at a scheduled interval, fetch the configured goal 510 with the goal details from the goals and objective manager service 450 in FIG. 4. The goal may be defined by selecting the calculated metric from the goal 520. A service, such a metric manager service 460 in FIG. 460, may get the definition of the calculated metric from the goal. The metric definition includes the KPI value that is used in the metric.

According to some embodiments of the present disclosure, get the pre-aggregated value for the KPI 530 may be operated by getting the aggregated value of the KPI for the defined period in the goal. The value of the KPI is fetched from the metric manager service 460 in FIG. 4.

According to some embodiments of the present disclosure, calculate the value of calculated metric 540 may be operated by using the KPI aggregated value, and then calculating the metric value by putting the KPI value in the calculated metric formula. This formula may be predefined in the performance management application 437b in FIG. 4. For example, KPI value*10/100.

According to some embodiments of the present disclosure, evaluate the goal condition 550 by putting the result calculated in operation 540 into the defined condition in the goal. The goal condition may be defined by the user while defining the goal. For example, condition may be metric value >80, which means that the goal is achieved if the value of the metric is greater than 80. Evaluating the condition results into Boolean value, i.e., true if the goal is achieved, else false.

According to some embodiments of the present disclosure, checking if the goal condition has been achieved 560. If it has been achieved, then, mark the status of the goal as achieved in the goals objectives database 455 in FIG. 4, e.g., mark the goal as completed 570.

According to some embodiments of the present disclosure, if the goal hasn't been achieved then no action is taken. After the goal is marked as completed, a goal notification may be sent 580 to a user who configured the goal with the details about the goal, metric, and agents.

According to some embodiments of the present disclosure, the goal details may be saved in an associated dashboard and report 590, such that it may be reflected as achieved in dashboard and reports.

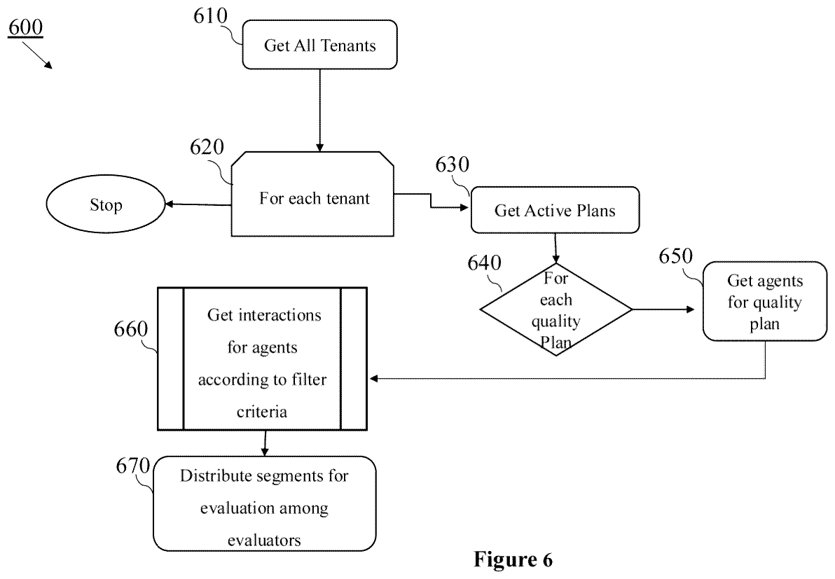

FIG. 6 schematically illustrates a high-level diagram 600 of quality management application, in accordance with some embodiments of the present invention.

According to some embodiments of the present disclosure, the cloud-based contact-center platform may operate a Quality Management (QM) application to get all tenants 610 from tenant manager and then perform the following operations for each tenant 620 until all tenants are processed.

According to some embodiments of the present disclosure, get active plans 630 by getting all active quality plans for the tenant. For each quality plan 640, the following operations may be performed till all active quality plans of the tenant are processed. Get agents for quality plan 650 by getting agents whose interactions need to be distributed for evaluation. Get interactions for agents according to filter criteria by fetching interactions for agents in plan according to filter criteria specified in plan. The filter criteria may include one or more outbound marketing KPI scores which are associated with the interaction.

According to some embodiments of the present disclosure, distribute interactions for evaluation among evaluators 670 by distributing fetched interactions among evaluators for evaluation according to a preconfigured number of evaluations for each evaluator.

According to some embodiments of the present disclosure, the fetching of the interactions for evaluation according to filter criteria may be performed by getting interaction filter criteria for a quality plan. The filter criteria may include one or more scores which were calculated by module for calculating a score of an outbound-marketing interaction 125b in FIG. 1B. Then, fetching by operating a service, such as interactions search service 145b in FIG. 1B the interactions from interactions-database 120b in FIG. 1B based on the criteria. The interactions that have been fetched may be returned by the interaction search service 145b into a database from which the QM application may distribute the interactions for evaluation.

FIG. 7 schematically illustrates a high-level diagram 700 of calculating KPIs for each tenant, in accordance with some embodiments of the present invention.

According to some embodiments of the present disclosure, the cloud-based contact-center platform may operate may fetch all tenants and for each tenant 710 preprocessing identification of product and feature 720.

According to some embodiments of the present disclosure, for each interaction 730 of the tenant calculate customer interest 740 and calculate agent sales effectiveness 750. Then, store the scores in a database 760, such as interactions-database 120b in FIG. 1B.

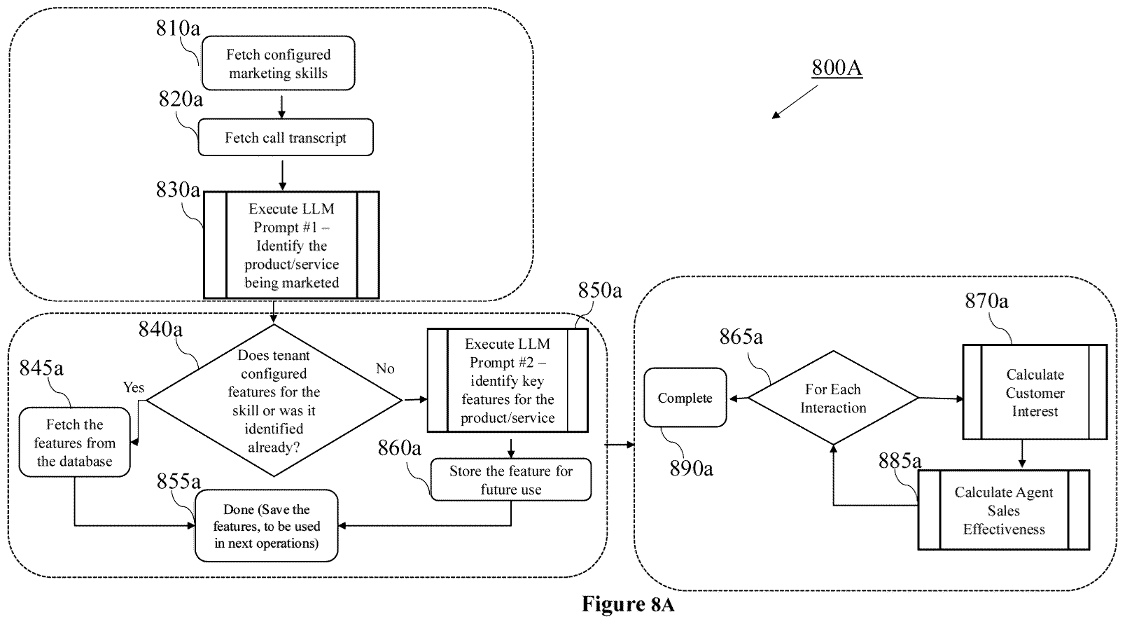

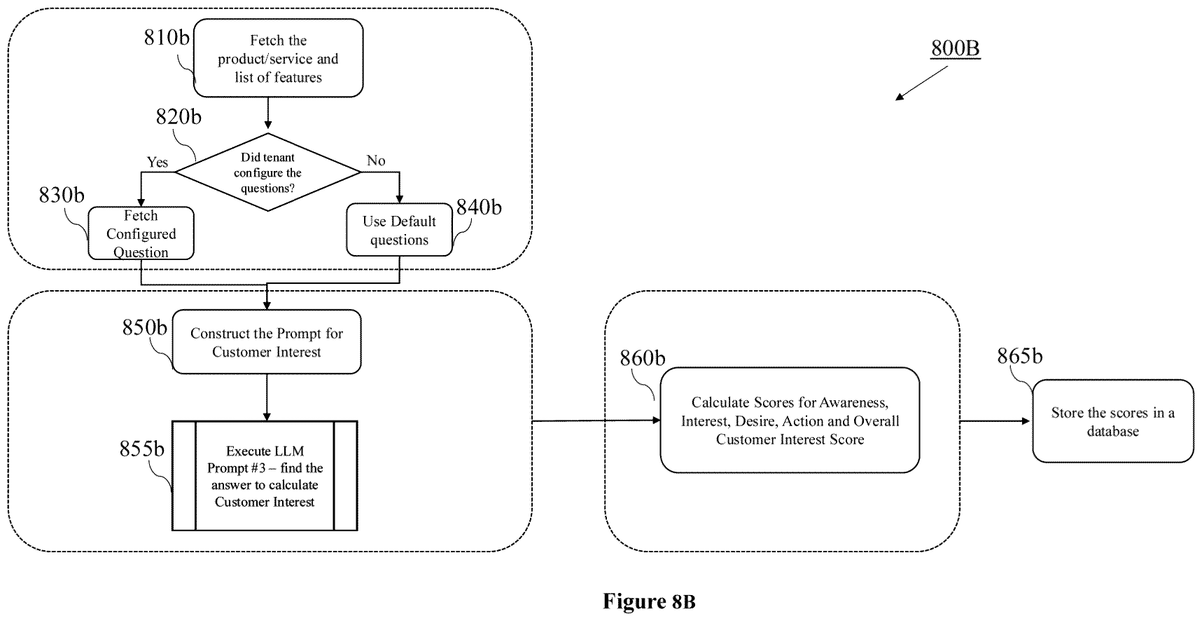

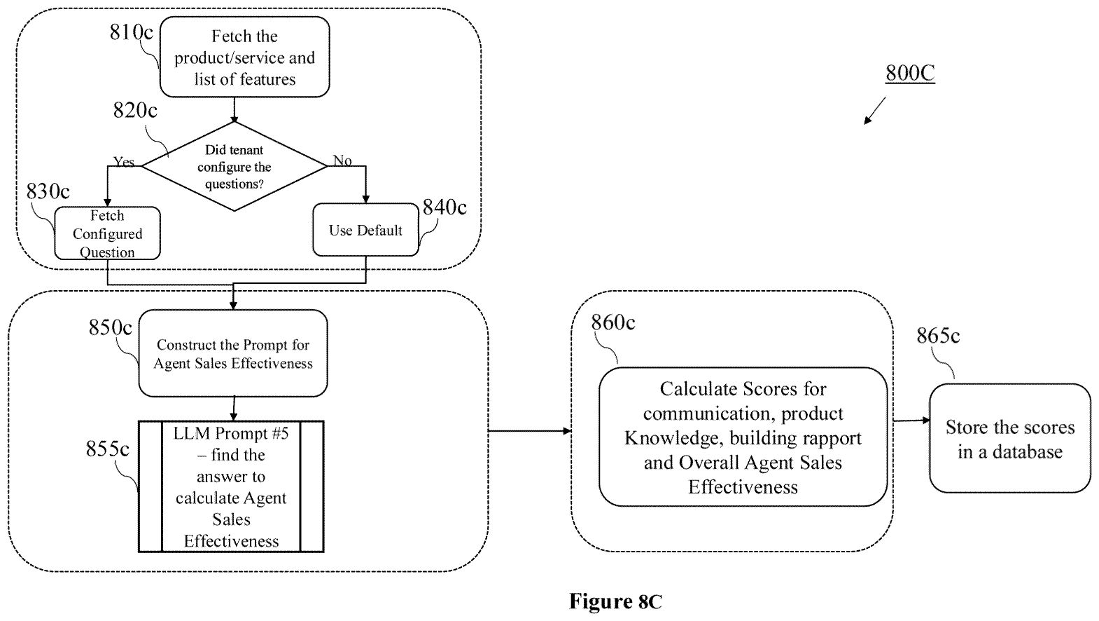

FIG. 8A schematically illustrates a high-level diagram 800A of preprocessing before calculating a score of an outbound-marketing interaction, in accordance with some embodiments of the present invention.

According to some embodiments of the present disclosure, for each tenant of all tenants fetch all the applicable interactions by fetching configured marketing skills 810a of the tenant and then based on the marketing skills fetching call transcript 820a. To identify the product or service being sold in the interaction with the customer, execute LLM prompt #1—identify product/service being marketed 830a. For example, a prompt as shown in FIG. 10A.

According to some embodiments of the present disclosure, checking does tenant configured features for the skill or was it identified already 840a. If it was configured by the tenant then, fetch the features from the database 845a and save the features to be used in next operations 855a. If the tenant didn't configure features, execute LLM prompt #2 to identify key features for the product/service 850a and store the features for future use 860a. For example, a prompt as shown in FIG. 10B.

According to some embodiments of the present disclosure, for each interaction 865a calculate customer interest score 870a which indicates the level of customer interest, which was generated by the Agent, as shown in FIG. 8B and calculate agent sales effectiveness score 885a which indicates the level of effectiveness that the agent was selling the product or service, as shown in FIG. 8C.

According to some embodiments of the present disclosure, the customer interest score and the agent sales effectiveness score may be stored in a database, such as interactions-database 120b in FIG. 1B.

FIG. 8B schematically illustrates a high-level diagram 800B of calculating customer interest score of an outbound-marketing interaction, in accordance with some embodiments of the present invention.

According to some embodiments of the present disclosure, the calculating customer interest score of an outbound-marketing interaction may be operated by fetching the product/service and a list of features 810b, as shown in FIG. 8A. Then, checking if the tenant configured questions 820b. If the tenant has configured questions, then fetching the configured questions 830b and if not then using default questions 840b.

According to some embodiments of the present disclosure, constructing a prompt for customer interest 850b by embedding the identified product or service, the list of features, the transcription of the outbound-marketing interaction and the configured questions in a prompt-template. Each question is related to a section in one or more preconfigured-sections. The preconfigured-sections may include at least one of: (i) awareness; (ii) interest; (iii) desire; (iv) action; and (v) sales-conversion.

According to some embodiments of the present disclosure, execute LLM prompt #3 to find the answer to calculate customer interest score 855b, as shown in FIGS. 11A-11B.

According to some embodiments of the present disclosure, the result of the LLM prompt #3 execution may include a score for each section, such that scores for each section may be calculated, for example, by calculating a score for awareness, interest, desire, action, and overall customer interest score 860b. The result of the LLM #3 execution may be provided in JavaScript Object Notation (JSON) structure.

According to some embodiments of the present disclosure, the calculated scores may be stored in a database 865b, such as interactions-database 120b in FIG. 1B.

FIG. 8C schematically illustrates a high-level diagram 800C of calculating an agent sales effectiveness score of an outbound-marketing interaction, in accordance with some embodiments of the present invention.

According to some embodiments of the present disclosure, calculating an agent sales effectiveness score of an outbound-marketing interaction may be performed by fetching the product/service and a list of features 810c, as shown in FIG. 8A. Then, checking if the tenant configured questions 820c. If the tenant has configured questions, then fetching the configured questions 830c and if not then using default questions 840c.

According to some embodiments of the present disclosure, constructing a prompt for agent sales effectiveness 850c by embedding the identified product or service, the list of features, the transcription of the outbound-marketing interaction and the configured questions in a prompt-template. Each question is related to a section in one or more preconfigured-sections. The preconfigured-sections may include communication, script_coverage, product_knowledge, and building_rapport.

According to some embodiments of the present disclosure, execute LLM prompt #4 to find the answer to calculate customer interest score 855C, as shown in FIGS. 12A-12B.

According to some embodiments of the present disclosure, the result of the LLM prompt #4 execution may include a score for each section, such that scores for each section may be calculated, for example, by calculating a score for communication, script_coverage, product_knowledge, and building_rapport and overall agent sales effectiveness score 860c.

According to some embodiments of the present disclosure, the calculated scores may be stored in a database 865c, such as interactions-database 120b in FIG. 1B.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for calculating a score of an outbound-marketing interaction, said computerized-method comprising:
(i) retrieving a transcription of the outbound-marketing interaction;
(ii) identifying a product that is being marketed in the outbound-marketing interaction by executing an Artificial Intelligence (AI) Large Language Model (LLM) with a check-product-prompt having the transcription embedded therein;
(iii) constructing a prompt based on: (a) the identified product; (b) one or more features of the identified product; (c) the transcription; and (d) one or more questions, wherein each question is related to a section in one or more preconfigured-sections;
(iv) executing the AI LLM with the constructed prompt to yield an answer and a question-score to each question of the one or more questions;
(v) calculating the score of the outbound-marketing interaction based on the question-score of each question; and
(vi) sending the score to one or more applications for follow-on actions based on the score.

2. The computerized-method of claim 1, wherein said computerized-method is operated for each outbound-marketing interaction of outbound-marketing interactions of the tenant, that have been retrieved based on preconfigured one or more outbound-skills of the tenant and have been conducted during a preconfigured period.

3. The computerized-method of claim 2, wherein said computerized-method is operated periodically for each tenant of the cloud-based contact-center platform.

4. The computerized-method of claim 1, wherein the product that is identified is one of a service or a physical product.

5. The computerized-method of claim 1, wherein the one or more features of the identified product are retrieved from product-features database of the tenant.

6. The computerized-method of claim 1, wherein the one or more features of the identified product are identified by executing the AI LLM with a check-features-prompt having the transcription embedded therein to yield the one or more features.

7. The computerized-method of claim 1, wherein the plurality of questions is one of: (i) preconfigured questions by the tenant; and (ii) a set of default-questions.

8. The computerized-method of claim 1, wherein the score is a customer-interest score, and wherein the one or more preconfigured-sections are customer-preconfigured-sections, and each section is a customer-section, said customer-preconfigured-sections comprising at least one of: (i) awareness; (ii) interest; (iii) desire; (iv) action; and (v) sales-conversion.

9. The computerized-method of claim 8, wherein the calculating of the customer-interest score is according to formula I:
$$customer\_interest score = {\sum }_{k = i}^{n} customer\_section \_weight i * customer\_section \_score i \qquad ( I )$$
whereby:
n is a number of the one or more customer-preconfigured-sections,
customer_section_weightᵢ is a weight that has been assigned to customer-sectionᵢ, and
customer_section_scoreᵢ is an average score of questions related to customer-sectionᵢ divided by maximum-score for customer-sectionᵢ.

10. The computerized-method of claim 1, wherein the score is agent-effectiveness score and wherein the one or more preconfigured-sections are agent-preconfigured-sections, and each section is an agent-section said agent-preconfigured-sections comprising at least one of: (i) communication; (ii) script_coverage; (iii) product_knowledge; and (iv) building_rapport.

11. The computerized-method of claim 10, wherein the calculating of the agent-effectiveness score is according to formula II:
$$agent\_effectiveness score = {\sum }_{k = i}^{n} agent\_section \_weight i * agent\_section \_score i \qquad ( II )$$
whereby:
n is a number of the one or more agent-preconfigured-sections,
agent_section_weightᵢ is a weight that has been assigned to agent-sectionᵢ, and
agent_section_scoreᵢ is an average score of agent-questions related to agent-sectionᵢ divided by maximum-score for agent-sectionᵢ.

12. The computerized-method of claim 1, wherein the one or more applications are at least one of: (i) Quality Management (QM) application; (ii) coaching application; and (iii) outbound-dialer service, and wherein the follow-on actions are at least one of: (i) configuring the QM application to filter interactions for evaluations based on a preconfigured threshold; (ii) assigning an agent of the related interaction to a coaching session; and (iii) prioritizing customer call-back via the outbound-dialer service and triggering outbound-interactions accordingly.

13. A computerized-system for calculating a score of an outbound-marketing interaction, said computerized-system comprising:
one or more processors;
an interactions-database; and
a memory to store the interactions-database,
said one or more processors are configured to:
(i) retrieve a transcription of the outbound-marketing interaction from the interactions-database;
(ii) identify a product that is being marketed in the outbound-marketing interaction by executing an Artificial Intelligence (AI) Large Language Model (LLM) with a check-product-prompt having the transcription embedded therein;
(iii) construct a prompt based on: (a) the identified product; (b) one or more features of the identified product; (c) the transcription; and (d) one or more questions,
wherein each question is related to a section in one or more preconfigured-sections;
(iv) execute the AI LLM with the constructed prompt to yield an answer and a question-score to each question of the one or more questions;
(v) calculate the score of the outbound-marketing interaction based on the question-score of each question; and
(vi) send the score to one or more applications for follow-on actions based on the score.
